(19) United States
(12) Patent Application Publication
(10) Pub. No.: US 2015/0294243 A1
(43) Pub. Date: Oct. 15, 2015

(54) METHOD TO PROPAGATE A SYSTEM LEVEL UTILIZATION GOAL TO INDIVIDUAL SYSTEM ELEMENTS

(71) Applicant: PROS, Inc., Houston, TX (US)

(72) Inventors: Wei WANG, Houston, TX (US); David NEWELL, Houston, TX (US); Darius WALCZAK, Houston, TX (US)

(73) Assignee: PROS, Inc., Houston, TX (US)

(21) Appl. No.: 14/249,963

(22) Filed: Apr. 10, 2014

(51) Int. Cl. G06Q 10/06

(52) U.S. Cl. CPC G06Q 10/063

(57) ABSTRACT

Techniques are disclosed for propagating a system level utilization goal to individual system elements. For example, a utilization goal such as a load factor goal for a group of airline flights in a given market segment and time period may be propagated to each flight in the group. When propagating a load factor goal to a group of airline flights, a goal value, historical load factors, and a capacity of each flight in the group may be used to determine a load factor target for each flight in the flight group. The propagated load factor targets are expected to be realizable by each flight in the flight group and, in the aggregate, satisfy the system level goal.

### BACKGROUND

1. Field

Embodiments of the invention provide techniques for goal propagation. More specifically, embodiments presented herein provide techniques for propagating a system level utilization goal to individual system elements from which the system level utilization is determined.

2. Description of the Related Art

Operators of commercial transportation and tourism services, e.g., airlines, passenger trains, hotels, cruise ships, rental car fleets, etc., use a variety of metrics to evaluate system performance. For example, passenger airlines frequently use load factors—the percentage of seats on a flight occupied by a passenger—as a metric for the performance of a flight or market segment. In addition to providing a measure of performance, system operators frequently assign a desired value for a system utilization metric (such as a load factor) to a given market segment. For example, an airline may assign a load factor goal of having 90% of available seats being occupied for flights between Boston and Chicago for the month of January.

Load factor goals may be set to help achieve targets for other revenue streams, including, e.g., additional revenue based on passenger volume, passenger discretionary purchases, premium seating fees, entertainment fees, luggage fees, as well as to achieve goals for ancillary revenue streams such as increased car or hotel bookings. Load factor goals may also be created when a carrier begins service for a new route. Load factor goals can also be part of publicly stated goals set by business management.

Once a load factor goal is assigned to a given market segment, the operator still needs to determine how to achieve that goal using the available flights within the market segment. However, doing so has remained largely a subject of guesswork for a market analyst, where individual load factor targets are assigned based on the analyst's best judgment.

### SUMMARY

One embodiment of the invention includes a computer-implemented method to propagate a system utilization goal to a plurality of system elements. This method may generally include receiving a value for the system utilization goal and also include determining, by operation of at least one processor, a scaling factor based on the value of the system utilization goal, a historical utilization value for each of the plurality of system elements, and a capacity associated with each system element. This method may also include determining an element utilization target for each system element based on the scaling factor.

In particular embodiments, the system utilization goal is a load factor goal for a flight group, the flight group comprising a set of flights in a given market for a given time period. In such a case, each historical utilization value may provide a historical load factor for one of the flights in the flight group and each element utilization target may provide a load factor target for one of the flights in the flight group.

Another embodiment includes a method to propagate a system load factor goal for a flight group. This method may generally include receiving a value for the system load factor goal. The flight group may correspond to a set of flights in a given market for a given time period. This method may also include determining, by operation of at least one processor, a respective load factor target for each flight in the flight group based on the value of the system load factor goal, a historical load factor of each flight in the flight group, and a capacity of each flight in the flight group. This method may also include assigning the respective load factor targets to the flights in the flight group

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings. Note, however, that the appended drawings illustrate only typical embodiments of this invention and are therefore not to be considered limiting of its scope, for the invention may admit to other equally effective embodiments.

FIG. 1 illustrates an example computing environment, according to one embodiment.

FIG. 2 illustrates a method for propagating a system level utilization goal (e.g., a load factor goal) to each flight within a given flight group, according to one embodiment.

FIG. 3 further illustrates aspects of the method first shown in FIG. 2, according to one embodiment.

FIG. 4 illustrates a method for adjusting load factor targets resulting from propagating the system level utilization goal to flights within a flight group, according to one embodiment.

FIG. 5A illustrates an example validity check for a load factor goal.

FIG. 5B illustrates an example of flights in a flight group being assigned a load factor target based on a load factor goal for that flight group, according to one embodiment.

FIG. 6 illustrates an example computing system configured to determine a propagated load factor target to assign to flights in a flight group based on a load factor goal and other input data, according to one embodiment.

### DETAILED DESCRIPTION

Embodiments of the invention provide techniques for propagating a system utilization goal to individual system elements. For example, in the context of an airline pricing and reservation system, an analyst at a carrier may specify a system level utilization goal indicating a desired load factor value for a group of flights in a given market (i.e., flights between two cities). From this, a goal propagation system assigns a load factor target to each flight in the flight group. In such a case, the system level utilization goal corresponds to the desired load factor value for the flight group and an element level utilization target corresponds to the load factor targets propagated to the individual flights in the flight group. Note, for clarity, the desired system utilization value is referred to as a “goal” and the system element utilization values are referred to as “targets.” Of course, depending on the system utilization metric and system under consideration, the corresponding system level goal and system element targets can be defined as needed.

Within any given market and for any given time period (i.e., a month) an airline may schedule a variety of flights, each with distinct characteristics (e.g., time of day, day of week, capacity etc.). These, and other characteristics, can have disparate impacts on the actual load factor of each individual flight. For example, flights departing on a Monday morning typically have higher load factors then flights departing on a Tuesday afternoon. Similarly, equipment with more capacity needs more passengers to achieve a given load factor. Further, changes to the flight schedule or equipment impacts both anticipated and realized load factors.

Thus, to determine how to actually achieve the desired load factor goal for a given group of flights, an analyst needs to account for the distinct nature of each flight. As a simple example, consider a market between two cities with three flights a day, seven days a week for the month of July. Should a carrier desire to achieve a load factor goal of 90% for this month/market segment, a naive approach would be to just assign a load factor target of 90% to each flight. If achieved, the goal for the flight group would be met, but this approach ignores the reality that some flights are anticipated to have higher load factors then others. Rather than use this naive approach, the analyst needs to determine a load factor target for each flight which has a relatively reasonable and achievable value, and one that, in the aggregate, can achieve the system level utilization goal for the flight group.

Embodiments presented herein use a system utilization goal, such as a load factor goal for a flight group, along with other data, to determine a load factor target to assign to each individual system element, such as each flight in the flight group. If each flight satisfies the individual load factor target, the desired load factor goal at the system level will be satisfied as well. Once the individual load factor targets are assigned, pricing and reservation systems may adjust inventory and booking class availability to help realize the load factor target for each of the flights. Thus, embodiments presented herein connect an overall system utilization goal to load factor targets that may be achieved by each flight in the flight group. In one embodiment, the desired system level utilization goal, historical load factors, and capacity of each flight are used to determine a load factor target for each flight in the group.

Note, embodiments of the invention are described below using an airline passenger booking system as a reference example of system in which a system level utilization goal is propagated to individual system elements. Specifically a load factor goal for a flight group (e.g., a month/market segment) is propagated to each flight in that group. The system level utilization goal may be propagated to individual flights by assigning an element level target, such as a load factor target, to each flight. The element level target assigned to each flight is expected to be both realizable by that flight and, in the aggregate, satisfy the system level goal. Of course, one of ordinary skill in the art will recognize that this example embodiment may be adapted for a variety of other systems or networks in which a system level utilization goal, typically specifying a percentage for some aspect of the network or aspect of system operations, is propagated in a realizable manner to individual elements of the system. For example, embodiments described herein may be adapted for use with load factor goals for airline flights, passenger trains, cruise ships, or booking levels for hotels, rental car fleets, etc., as well as to space utilization for shipping services, e.g., cargo carriers and package delivery providers.

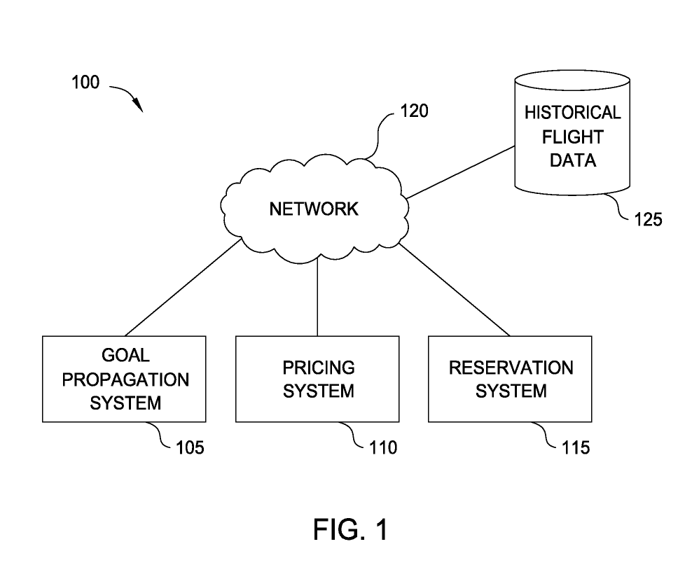

FIG. 1 illustrates an example computing environment, according to one embodiment. As shown, the computing environment 100 includes a goal propagation system 105, pricing system 110, reservation system 115, and a database 125 storing historical flight data, each connected to a network 120. The pricing system 110 generally corresponds to computer systems and related infrastructure used to determine a price for a potential booking. And the reservation system 115 generally corresponds to computer systems and related infrastructure used to manage the bookings for each flight in a flight schedule. As known, airline operators typically allocate seat inventory using a number of booking classes, as well as publish a fare tariff, which lists prices and restrictions for bookings in each booking class. Once a flight schedule and tariff are published, the reservation system 115 generally allows passengers (and airline employees) to book inventory on a given flight by reserving seats in a given booking class for a price determined by the pricing system 110, according to booking class availability and the fare tariff.

The pricing and reservations systems 110, 115 also allow an operator to understand at any given time the then currently booked load factor for any given flight (prior to departure) as well as review actual or realized load factors following a flight departure. For example, database 125 may store both current load factors and realized load factors for departed flights. Thus, the database 125 may store historical utilization levels for prior departures as well as current utilization levels (i.e., current bookings or predicted load factors) for future departures.

In one embodiment, the goal propagation system 105 generally corresponds to computer systems and related infrastructure used to assign a load factor target to each flight within a given month/market segment (or other desired flight group) based on a system level utilization goal (e.g., a desired load factor goal for the flight group). As described in greater detail below, the goal propagation system 105 may determine a load factor target to assign to a given flight using a scaling factor, which itself may be determined from a load factor goal, historical load factors, and a seating capacity of each flight in a flight group.

Further, once assigned, the pricing and reservations systems 110, 115 may use the assigned load factor target to adjust what fares are offered or adjust the inventory for booking classes in order to realize the target load factor on each flight, and in turn, satisfy the system level goal. For example, assume thirty days prior to departure the booked load factor for a given flight is below the load factor target assigned by the goal propagation system 105. In such a case, the pricing and reservation systems 110, 115 may allocate additional booking class inventory for lower priced fares on the tariff (or publish a new tariff). Conversely, once the bookings on a flight satisfy the target load factor, the pricing and reservation systems 110, 115 could limit inventory in booking classes associated with lower fare prices. Doing so may increase passenger revenue, while maintaining the achieved the load factor target.

Note, while illustrated in FIG. 1 as a single pricing system 110, reservation system 115, goal propagation system 105, and database 125, one of ordinary skill in the art will recognize that airline (and other network) reservation and pricing systems are typically hosted on large numbers of computing servers connected by one or more data centers. Further, the goal propagation system 105, pricing system 110 and reservation system 115 are included to be representative of both physical computing systems hosting the described applications as well as virtual machine instances executing these applications within a computing cloud. Network 120 may correspond to a local network segment at a data center connecting systems 105, 110, 115, and 125 as well as networks connecting these systems across data centers, including the Internet.

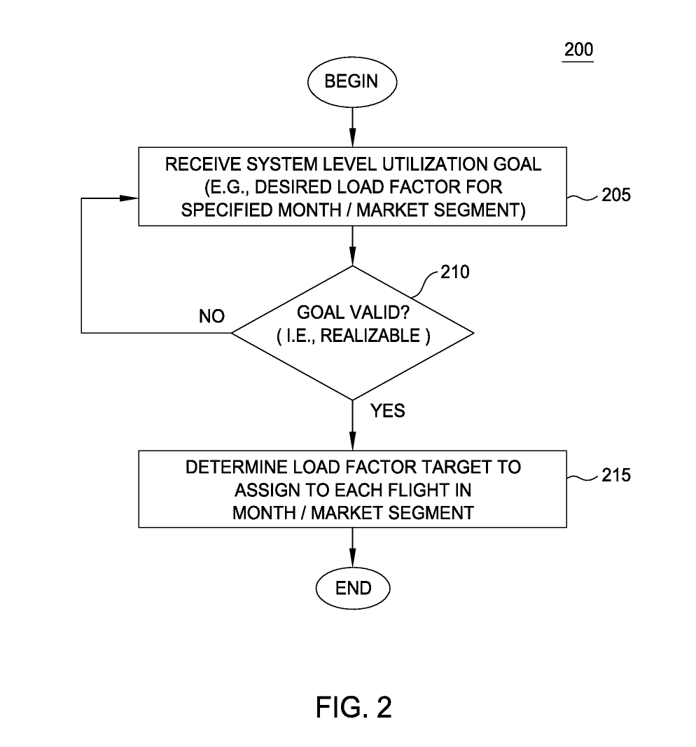

FIG. 2 illustrates a method 200 for propagating a system level utilization goal (e.g., a load factor goal) to each flight within a given flight group, according to one embodiment. As shown, the method 200 begins at step 205 where an operator specifies a system utilization goal for a given flight group. For example, an analyst at an airline may assign a load factor goal for a flight group, such a desired aggregate load factor for flights between two cities for a given month. As noted above, such a load factor goal may be set for a variety of reasons, including, e.g., a desire to increase revenue streams not directly related to ticket revenue, a desire to achieve a certain market share within a new market, or to help meet investor commitments.

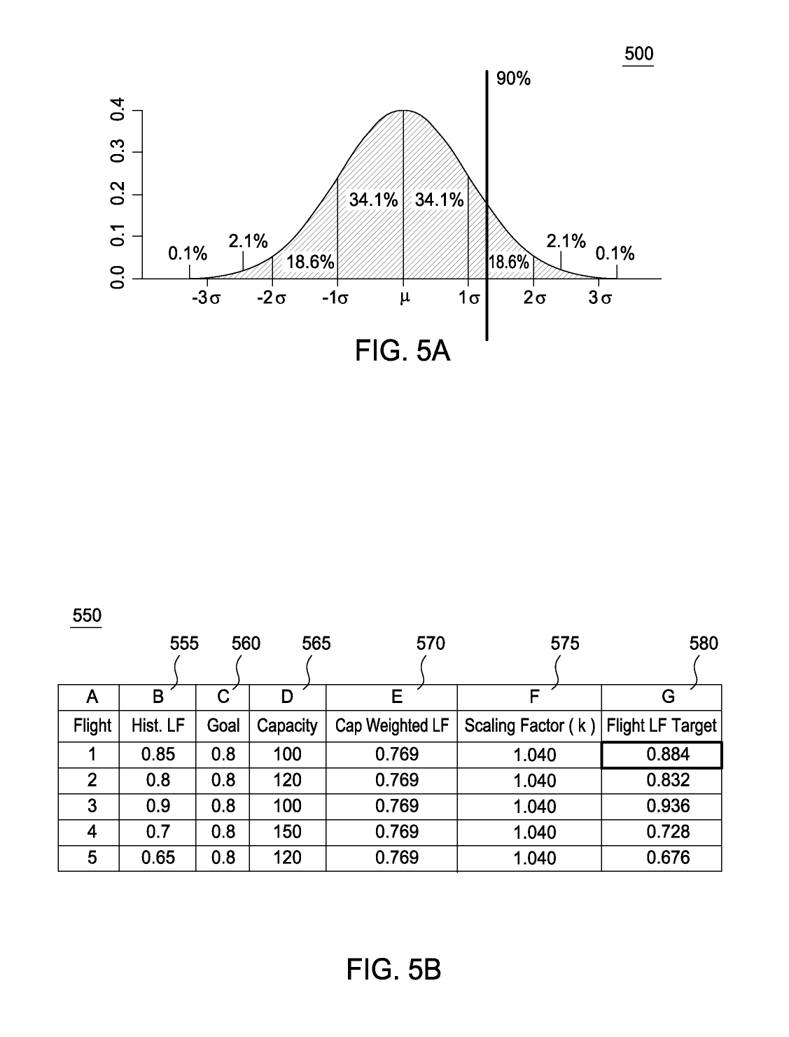

In one embodiment, the goal propagation system 105 may validate the load factor goal (step 210). For example, the goal propagation system 105 may determine a distribution of historical load factors of flights in the given market/month. Once determined, the system reports how likely it is that the desired load factor goal is achievable based on the observed distribution. If the goal is not validated, the system issues an error message. Otherwise, the desired goal is approved and propagated to the individual flights. FIG. 5A illustrates a normal distribution 500 of load factors, where a goal of 90% falls within a second standard deviation. Assuming the system is configured to validate goals that fall within two standard deviations, the goal of 90% would be approved. Of course, the actual limits of whether the system considers a target goal as valid may be set as a matter of preference.

Referring again to method 200, at step 210, if the goal propagation system 105 determines that the desired load factor goal for a flight group is invalid, then the system returns to step 205 and prompts the user to revise the specified value of the desired load factor goal for the flight group.

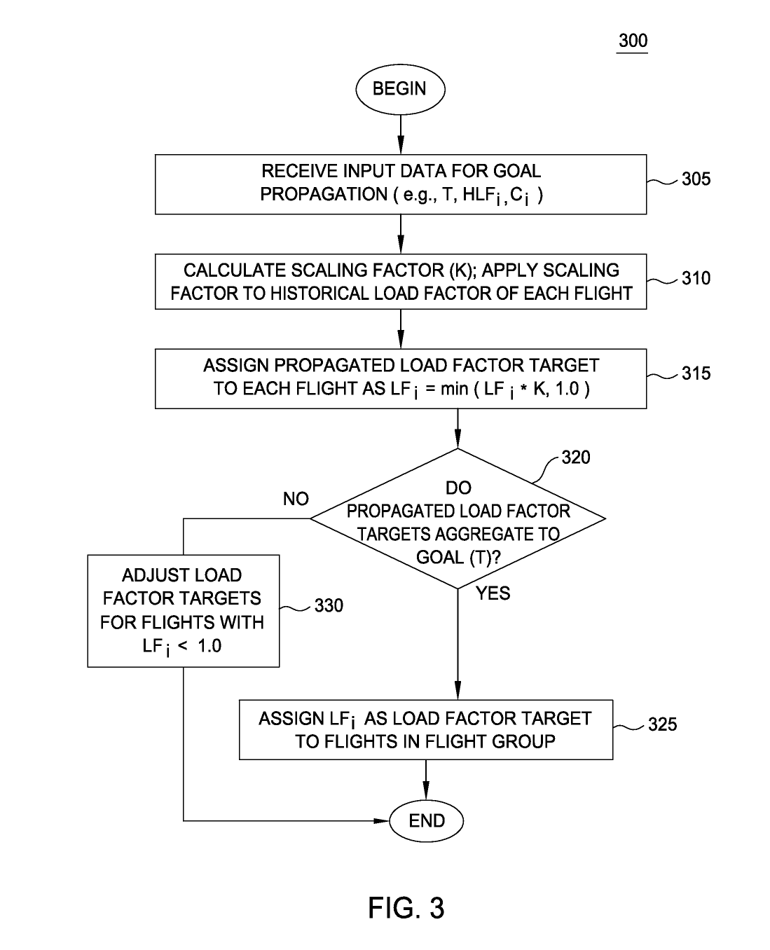

Once a valid load factor goal is received, the goal propagation system 105 determines an element utilization target, such as a load factor target, for each flight in the flight group (step 215). FIG. 3 further illustrates step 215, according to one embodiment. More specifically, FIG. 3 illustrates a method for propagating a system utilization goal (e.g., a load factor goal for a flight group) by assigning an element utilization target to each system element (e.g., by assigning a load factor target to each flight within a flight group). In one embodiment, the goal propagation system 105 determines the load factor targets using a scaling factor, itself determined from a historical load factor of each flight in the flight group, a load factor goal for the flight group, and a seating capacity of each flight in the flight group.

As shown, the method 300 begins at step 305 where the goal propagation system receives a set of input data used to determine a load factor target to assign to each flight in a flight group (referred to as LFᵢ for the i^{th} flight). For example, the inputs may include a load factor goal (T) for a set of flights, a historical load factor (referred to as HLFᵢ for the i^{th} flight), and a capacity for each flight in the flight group (referred to as Cᵢ for the i^{th} flight).

Note, in one embodiment, the historical load factors (HLFᵢ) may be based on actual load factors for a given time period. However, the historical load factors may also be based on estimated load factors. For example, in the case of an airline entering a new market, the historical load factors may be determined using load factors for existing flights that are predicted to model the behavior of flights in the newly entered market. Such a process is sometimes referred to as flight segmentation—the matching and grouping of flights expected to experience similar load factors to one another—and a variety of approaches for flight segmentation have been developed. In context of the embodiments presented herein, actual historical load factors, as well as any suitable substitutes (such as load factors based on segmentation) may be used to determine the propagated load factor targets.

Once the inputs are received, and after performing any validation, the goal propagation system 105 may determine a scaling factor (K) used to scale the historical load factor (HLFᵢ) of each flight in the flight group as follows:

LFᵢ=(HLFᵢ*K) (eq. 1)

As shown, the propagated load factor target for a given flight is the product of the historical load factor and the scaling factor. In one embodiment, the scaling factor (K) may itself be determined from the load factor goal (T) and a capacity weighted average (CWA) of the flights in the flight group. In one embodiment, the capacity weighted average is determined as follows:

CWA=(HLF₁*C₁+HLF₂*C₂+ . . . +HLFₙ*Cₙ)/(C₁+C₂+ . . . +Cₙ) (eq. 2)

In equation 2, the CWA is determined by dividing the historical load factors weighted by capacity by the total capacity. Using the CWA, the scaling factor K may be determined as follows:

K=T/CWA (eq. 3)

As shown, the scaling factor K is determined by dividing the load factor goal (T) by the CWA. FIG. 5B shows an example table 550 of propagated load factors determined for a given flight group using the equations shown above. As shown, column B (555) shows a historical load factor for five flights. In this example, an analyst has set a load factor goal of 0.8 (shown in column C 560). Column D 565 shows a capacity for each of the five flights. From the data in columns B, C, and D, the capacity weighted average (CWA) and scaling factor (K) are shown in columns E 570 and F 575. In this example, the capacity weighted average (CWA) and scaling factor (K) have been computed using the equations set forth above. Lastly, column G 580 shows the load factor target assigned to each flight.

Referring again to FIG. 3, at step 315, the goal propagation system assigns the load factor target to each flight, as determined above. Note, in one embodiment, the goal propagation system limits the maximum load factor target for any given flight to 1.0. That is, the load factor target may be prohibited from exceeding 100%. However, depending on the load factor goal, historical load factors, and capacity, the load factors LFᵢ determined for a given flight may result in values exceeding 1.0. In such case, the goal propagation system may limit any such propagated load factors LFᵢ to 1.0.

At step 320, the goal propagation system determines whether the propagated load factor targets, in the aggregate, will satisfy the load factor goal (T) for the flight group. If so, at step 325, the propagated load factors are assigned to the flights in the flight group. If none of the propagated goals were truncated to 1.0 (at step 315) then the load factor targets are expected to aggregate to the load factor goal. However if some flights are truncated to 1.0, the reduced targets might result in load factor targets that, in the aggregate, will not satisfy the desired load factor goal for the flight group (even if the individual load factor targets are met). In such a case, at step 330, the goal propagation system may adjust load factor targets for flights in the flight group with a propagated load factor below 1.0. That is, the initial goal propagation distributes a desired load factor goal among flights in the flight group. Once done, if any flights are limited to a load factor target of 1.0, the load factor targets assigned to other flights in the flight group may be adjusted to compensate.

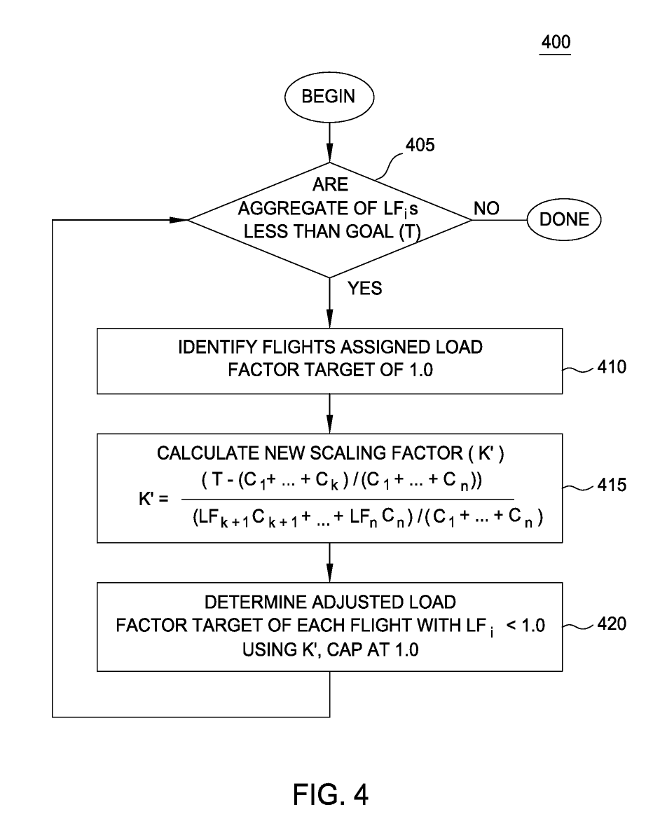

FIG. 4 illustrates a method 400 for adjusting a load factor target assigned to flights within a flight group, according to one embodiment. As shown, the method 400 begins at step 405, where the goal propagation system determines whether an aggregate of the load factor targets assigned to a flight group is less than the load factor goal (T) for that flight group. The aggregate load factor may be determined as follows:

Aggregate Load Factor=(LF₁*C₁+ . . . +LFₙ*Cₙ)/(C₁+ . . . +Cₙ) (eq. 4)

Note, step 405 of method 400 generally corresponds to step 320 of method 300. If the aggregate load factor satisfies the load factor goal (T), then no adjustment is needed, and method 400 ends without adjusting any of the propagated LFᵢ load factor targets. The remaining steps of method 400 generally correspond to step 330 of FIG. 3, where load factor targets not exceeding 1.0 are adjusted to satisfy, in the aggregate, the desired load factor goal (T), in cases where some of the assigned load factor targets were capped at 1.0. At step 410, the goal propagation system identifies flights assigned a load factor target of 1.0 (i.e., a load factor of 100%). These flights may be ordered as 1, . . . , k, with the remaining flights (ones assigned a load factor target of less than 1.0) are ordered as k+1, . . . , n. Once ordered, at step 415, a new scaling factor (K′) is calculated. The new scaling factor (K′) is used to adjust the load factor targets of flights with a load factor less than 1.0. In one embodiment, the new scaling factor may be calculated as follows:

$${K}^{′} = \frac{( T - ( {C}_{1} + … + {C}_{k} ) / ( {C}_{1} + … + {C}_{n} ) )}{( L {F}_{k + 1} {C}_{k + 1} + … + L {F}_{n} {C}_{n} ) / ( {C}_{1} + … + {C}_{n} )} \qquad ( eq . 5 )$$

Once determined, the new scaling factor (K′) is used to determine an adjusted load factor for flights k+1, n (step 420). In one embodiment, the adjusted LFᵢ, may be determined as the product of the current LFᵢ and the new scaling factor K′, as follows:

Adjusted LFᵢ=min(K′*LFᵢ, 1) (eq. 6)

Once the adjusted load factor targets are determined, the method 400 returns to step 405, where the goal propagation system evaluates the aggregate of the load factors against the load factor goal (T). If the aggregate remains below the goal (T), the load factors (LFᵢ) are again grouped into ones with a value of 1.0 (or 100%) and ones with a load factor target less than 1.0. The latter group of load factors are again adjusted using steps 410, 415 and 420, until the aggregate test of step 405 is satisfied.

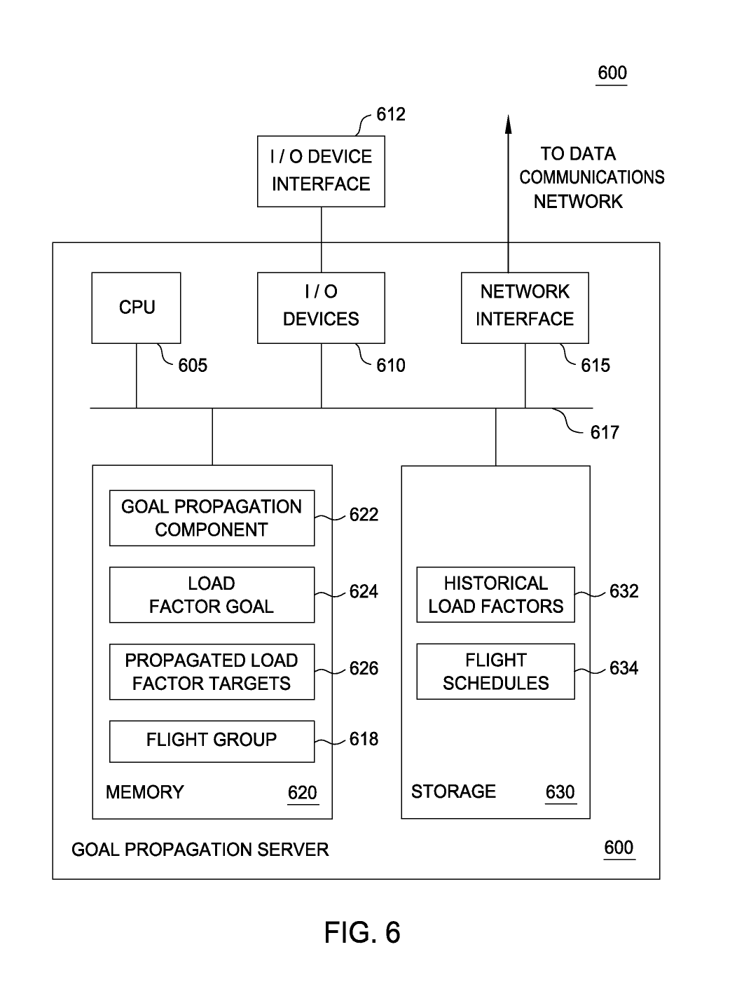

FIG. 6 illustrates an example computing system 600 configured to determine a propagated load factor target to assign to a flights in a group based on a load factor goal and other input data, according to one embodiment. As shown, the computing system 600 includes, without limitation, a central processing unit (CPU) 605, a network interface 615, a memory 620, and storage 630, each connected to a bus 617. The computing system 700 may also include an I/O device interface 610 connecting I/O devices 612 (e.g., keyboard, mouse, and display devices) to the computing system 600. Further, in context of this disclosure, the computing elements shown in computing system 600 may correspond to a physical computing system (e.g., a system in a data center) or may be a virtual computing instance executing within a computing cloud.

The CPU 605 retrieves and executes programming instructions stored in the memory 620 as well as stores and retrieves application data residing in the memory 630. The interconnect 617 is used to transmit programming instructions and application data between the CPU 605, I/O devices interface 610, storage 630, network interface 615, and memory 620. Note, CPU 605 is included to be representative of a single CPU, multiple CPUs, a single CPU having multiple processing cores, and the like. And the memory 620 is generally included to be representative of a random access memory. The storage 630 may be a disk drive or solid state storage device storage device. Although shown as a single unit, the storage 630 may be a combination of fixed and/or removable storage devices, such as fixed disc drives, removable memory cards, or optical storage, network attached storage (NAS), or a storage area-network (SAN).

Illustratively, the memory 620 includes a goal propagation component 622, load factor goal data 624, propagated load factor targets 626, and flight group data 628. The storage 630 includes historical load factor data 632 and flight schedules 634. As described, the goal propagation component 605 may provide one or more application programs configured to propagate a load factor goal to flight group 618, e.g., a month/market segment between two cities derived from flight schedules 634. To do so, the goal propagation component 622 may use the load factor goal 624, and other input data, such as the historical load factors 632 (or segmented flight load factor data) to determine propagated load factor targets 626 using the techniques set forth above.

Advantageously, embodiments presented herein connect a system utilization goal, such as a load factor goal for a flight group, to system element utilization targets, such as a load factor target determined for each flight in the flight group. Stated differently, the goal propagation techniques disclosed above provide a mechanism for a carrier to actually achieve a desired load factor goal for a group of flights by determining a reasonable load factor target for each flight in the group. In one embodiment, the desired load factor goal, historical load factors, and capacity of each flight are used to determine the load factor target for each flight in the group.

In the preceding, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet. In context of the present invention, the goal propagation system may provide a cloud based application used by an analyst to assign a system level utilization goal to a flight group. Further, once the load factor goal is propagated to flights in the flight group, pricing, reservation, and booking systems may adjust booking class inventory or fare tariffs to help achieve the load factor target for each flight, and, in the aggregate, achieve the aggregate load factor goal for the flight group.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A computer-implemented method to propagate a system utilization goal to a plurality of system elements, the method comprising:
receiving a value for the system utilization goal;
determining, by operation of at least one processor, a scaling factor based on the value for the system utilization goal, a historical utilization value for each of the plurality of system elements, and a capacity associated with each system element; and
determining an element utilization target for each system element based on the scaling factor.

2. The method of claim 1, wherein the system utilization goal is a load factor goal for a flight group, the flight group comprising a set of flights in a given market for a given time period.

3. The method of claim 2, wherein the historical utilization value of each system element specifies a historical load factor of one of the flights in the flight group.

4. The method of claim 2, wherein the element utilization target for each system element specifies a load factor target for one of the flights in the flight group.

5. The method of claim 4, further comprising, adjusting an availability of one or more booking classes for one or more of the flights in the flight group based on the corresponding load factor targets.

6. The method of claim 1, further comprising, capping the determined element utilization targets to a maximum of 1.0.

7. The method of claim 6, further comprising, adjusting the element utilization targets for one or more of the system elements having a determined element utilization target less than 1.0.

8. The method of claim 1, further comprising, prior to determining the element utilization target for each system element, determining whether the received value for the system utilization goal falls within a realizable range.

9. A computer-readable storage medium storing instructions, which, when executed on a processor, performs an operation to propagate a system utilization goal to a plurality of system elements, the operation comprising:
receiving a value for the system utilization goal;
determining a scaling factor based on the value for the system utilization goal, a historical utilization value for each of the plurality of system elements, and a capacity associated with each system element; and
determining an element utilization target for each system element based on the scaling factor.

10. The computer-readable storage medium of claim 9, wherein the system utilization goal is a load factor goal for a flight group, the flight group comprising a set of flights in a given market for a given time period.

11. The computer-readable storage medium of claim 10, wherein the historical utilization value of each system element specifies a historical load factor of one of the flights in the flight group.

12. The computer-readable storage medium of claim 10, wherein the element utilization target for each system element specifies a load factor target for one of the flights in the flight group.

13. The computer-readable storage medium of claim 12, wherein the operation further comprises, adjusting an availability of one or more booking classes for one or more of the flights in the flight group based on the corresponding load factor targets.

14. The computer-readable storage medium of claim 9, wherein the operation further comprises, capping the determined element utilization targets to a maximum of 1.0.

15. The computer-readable storage medium of claim 14, wherein the operation further comprises, adjusting the element utilization targets for one or more of the system elements having a determined element utilization target less than 1.0.

16. The computer-readable storage medium of claim 9, wherein the operation further comprises, prior to determining the element utilization target for each system element, determining whether the received value for the system utilization goal falls within a realizable range.

17. An apparatus, comprising:
a processor; and
a memory hosting an application, which, when executed on the processor, performs an operation to propagate a system utilization goal to a plurality of system elements, the operation comprising:
receiving a value for the system utilization goal,
determining a scaling factor based on the value for the system utilization goal, a historical utilization value for each of the plurality of system elements, and a capacity associated with each system element, and
determining an element utilization target for each system element based on the scaling factor.

18. The apparatus of claim 17, wherein the system utilization goal is a load factor goal for a flight group, the flight group comprising a set of flights in a given market for a given time period.

19. The apparatus of claim 18, wherein the historical utilization value of each system element specifies a historical load factor of one of the flights in the flight group.

20. The apparatus of claim 18, wherein the element utilization target for each system element specifies a load factor target for one of the flights in the flight group.

21. The apparatus of claim 20, wherein the operation further comprises adjusting an availability of one or more booking classes for one or more of the flights in the flight group based on the corresponding load factor targets.

22. The apparatus of claim 17, wherein the operation further comprises, capping the determined element utilization targets to a maximum of 1.0.

23. The apparatus of claim 22, wherein the operation further comprises, adjusting the element utilization target for one or more of the system elements having a determined element utilization target less than 1.0.

24. The apparatus of claim 17, wherein the operation further comprises, prior to determining the element utilization target for each system element, determining whether the received value for the system utilization goal falls within a realizable range.

25. A computer-implemented method to propagate a system load factor goal for a flight group, the method comprising:
receiving a value for the system load factor goal, the flight group comprising a set of flights in a given market for a given time period;
determining, by operation of at least one processor, a respective load factor target for each flight in the flight group based on the value of the system load factor goal, a historical load factor of each flight in the flight group, and a capacity of each flight in the flight group; and
assigning the respective load factor targets to the flights in the flight group.
